(19) United States
(12) Patent Application Publication
(10) Pub. No.: US 2007/0164842 A1
(43) Pub. Date: Jul. 19, 2007

(54) Electro-Optic Radiometer to Detect Radiation

(75) Inventor: Mary K. Koenig, Seattle, WA (US)

Correspondence Address: FISH & RICHARDSON P.C., PO BOX 1022, MINNEAPOLIS, MN, 55440-1022, US

(73) Assignee: Lumera Corporation, Bothell, WA (US)

(21) Appl. No.: 11/624,564

(22) Filed: Jan. 18, 2007

Related U.S. Application Data
(60) Provisional application No. 60/760,146, filed on Jan. 19, 2006.

(51) Int. Cl. H01P 7/00

(52) U.S. Cl. 333/219.2

(57) ABSTRACT

Apparatus and associated systems, methods and computer program products relate to an electro-optic device that includes a drive electrode that is substantially resonant with millimeter wave and/or terahertz wave radiation. In various embodiments, the drive electrode may comprise at least one structure with an absorption resonance at the frequency of interest (e.g., 94 gigahertz, 120 gigahertz, 1 terahertz). In some embodiments, such periodic structures may be terminated with a characteristic impedance that substantially enhances the absorption resonance.

### CROSS-REFERENCE TO RELATED APPLICATIONS

This application claims priority to U.S. Provisional Application Ser. No. 60/760,146, entitled “Electro-optic Radiometer to Detect Radiation,” which was filed by Koenig on Jan. 19, 2006, the entire contents of which are incorporated herein by reference.

### BACKGROUND

Millimeter and terahertz wave radiation detection is important in many imaging applications. Terahertz imaging systems typically rely on down converting the terahertz frequency to a lower intermediate frequency or direct detecting with a sensor suited to terahertz frequency, for example see S. M. Wentworth, R. L. Rogers, J. G. Heston, and D. P. Neikirk, Twin-slot multi-layer substrate-supported antennas and detectors for terahertz imaging, First International Symposium on Space Terahertz Technology, University of Michigan, Ann Arbor, Mich., Mar. 5-6, 1990, pp. 201-213. In these systems, noise is a limiting factor due to the small signal levels of the detected terahertz power levels. Accordingly, to reduce the overall system noise, terahertz antennas have been designed and integrated into receiver systems designed to reduce noise and local oscillator (LO) coupling factors. For a survey of many of the antenna designs see G. M. Rebeiz, Millimeter-Wave and Terahertz Integrated Circuit Antennas; Proceedings of the IEEE. Vol. 80. No. 11; November 1992. In order to reduce cost and complexity there has been much study in the use of planar antennas. Rebeiz discusses broadside antennas (dipoles, slots, log-periodic, etc) on thick dielectric substrates, end-fire antennas, and antennas on thin dielectric membranes. In general these antennas have been specifically designed to match with the associated mixers and detectors in the down-converted and direct-detected integrated systems. Plugge, et al. in U.S. Pat. No. 6,252,557 describe a method of converting radio frequency signals to optical signals over a very large response bandwidth.

### SUMMARY

Apparatus and associated systems, methods and computer program products relate to an electro-optic device that includes a drive electrode that is substantially resonant with millimeter wave and/or terahertz wave radiation. In various embodiments, the drive electrode may comprise at least one structure with an absorption resonance at the frequency of interest (e.g., 94 gigahertz, 120 gigahertz, 1 terahertz). In some embodiments, such periodic structures may be terminated with a characteristic impedance that substantially enhances the absorption resonance.

In one embodiment, the electrode may include, for example, a periodic series of inductive transmission lines and/or parallel capacitive structures that may be spaced substantially at quarter wavelength or half wavelength intervals, and/or integer multiples of such spacings. In other embodiments, the electrode may include a transmission line and a series of parallel capacitive structure that are distributed at quarter wavelength or half wavelength points along the transmission line. Examples of capacitive structures are stepped impedance lines, radial stubs, open stubs, and slots. The periodic lines may be terminated with an impedance that enhances the absorption (e.g., resonant) quality of the electrode.

In an exemplary embodiment, a device includes: a) a ground plane electrode; b) an optical waveguide comprising an electro-optic polymer; and c) a drive electrode that is resonant with millimeter wave or terahertz wave radiation, wherein the field generated between the drive electrode and the ground plane electrode passes through at least part of the electro-optic polymer. In some embodiments, the electro-optic polymer is the core of the optical waveguide and the waveguide further comprises two clads. Both clads may include passive polymers.

In another exemplary embodiment, an electro-optical system to image received electromagnetic signals includes a receiving electrode arranged in a first planar layer to receive an incident electromagnetic signal. The receiving electrode is tuned to absorb the received electromagnetic signal within a predetermined band of frequencies, and to attenuate substantially absorption of the received electromagnetic signal outside of the predetermined band. The system also includes an electro-optically active optical waveguide in a second planar layer substantially parallel to the first planar layer such that an optical signal propagating in the waveguide responds to the absorbed electromagnetic signals. The response of the optical signal to the absorbed electromagnetic signal may comprise, for example, a change in velocity (e.g., associated with changes in the refractive index of the electro-optic material), a change in amplitude, a change in frequency, and/or a change in phase of the optical signal.

In some embodiments, the electro-optic device includes an optical waveguide, wherein at least part of the optical field travels through an electro-optic material (e.g., the electro-optic material comprises either the core of the optical waveguide, a cladding of the optical waveguide, or both.), and a drive electrode that changes the electro-optic properties of the electro-optic material. The drive electrode may be electrically floating, i.e., not connected to other circuitry. The change in the electro-optic material can be used to control, for example, the phase, intensity, or wavelength of light in an optical device. Electro-optic devices include, for example, intensity modulators, phase modulators, tunable filters, micro-ring resonators, and Mach-Zehnder modulators. The electro-optic device may include other electrodes that can be used, for example, to apply a DC, low frequency, or thermal bias. In some embodiments, the electro-optic material may be an electro-optic polymer. The optical waveguide may further include passive polymers, other electro-optic polymers, and/or inorganic materials such as, for example, SiOₓ.

Embodiments of the electro-optic device including a drive electrode that is resonant with millimeter wave or terahertz wave radiation can be arranged in arrays. With these devices, free space millimeter wave or terahertz wave radiation can be detected optically with high gain.

Some embodiments may provide one or more advantages. For example, frequency selectivity may be useful in various applications, such as communication, imaging, and radiometry. Absorbing radiation energy within a selected frequency band may improve noise margins and/or enhance signal to noise ratios, which may thereby improve effective range or performance of a system. Some devices made from electro-optic polymers may have low dielectric constant, high electro-optic activity, and operate at high frequency, and may realize increased device density (e.g., pixels per unit area) in arrays, operate more efficiently with less or no high frequency amplifiers, and/or function from microwave to terahertz frequencies.

The details of one or more embodiments are set forth in the accompanying drawings and the description below. Other features, objects, and advantages will be apparent from the description and drawings, and from the claims.

### BRIEF DESCRIPTION OF THE FIGURES

FIG. 1 illustrates the operation of an exemplary electro-optic device with a resonant drive electrode.

FIG. 2 illustrates one embodiment of the resonant drive electrode.

FIG. 3 illustrates an exemplary frequency response characteristic for the drive electrode.

FIG. 4 illustrates one embodiment of the resonant drive electrode.

FIG. 5 illustrates one embodiment of the resonant drive electrode.

FIG. 6 illustrates plan and cross-section views of an exemplary Mach-Zehnder interferometer polymer waveguide device with a resonant drive electrode.

Like reference symbols in the various drawings indicate like elements.

### DETAILED DESCRIPTION OF ILLUSTRATIVE EMBODIMENTS

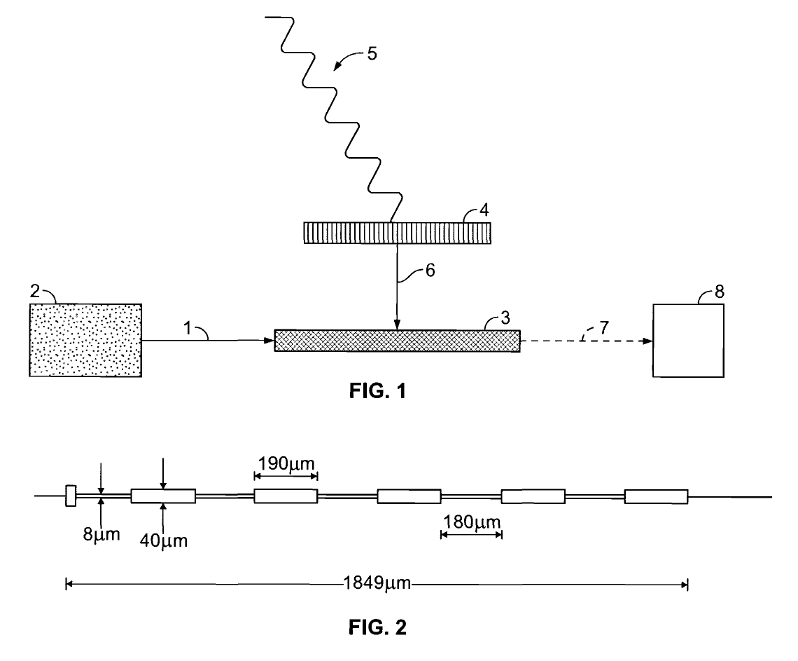

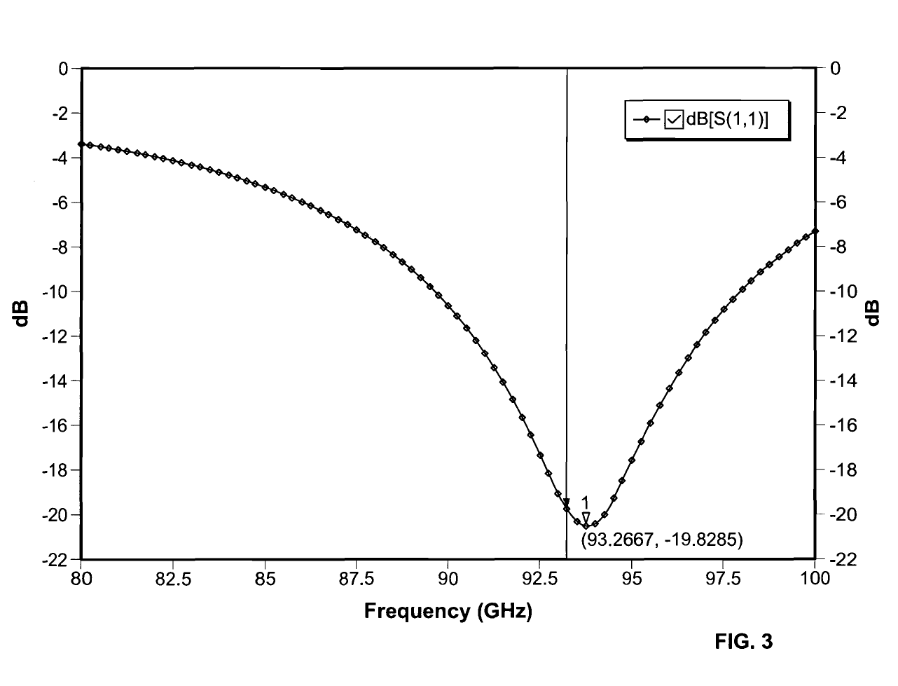

One exemplary embodiment of an electro-optic device includes a drive electrode that is resonant with millimeter wave or terahertz wave radiation. The device may be used to detect free-space millimeter or terahertz wave radiation. FIG. 1 illustrates schematically how millimeter wave or terahertz wave radiation may be detected with the electro-optic device. Light (1) from an optical source (2) is coupled into an optical waveguide (3) of the electro-optic device, and the optical waveguide (3) comprises an electro-optic material. A drive electrode (4) that is resonant with a millimeter wave or terahertz wave radiation (5) produces a voltage (6) that changes an optical signal (7) exiting the optical waveguide. The change in the optical signal (7) is detected at a detector (8) that converts the optical signal to an electrical signal. In some embodiments, the resonant drive electrode may include periodic parallel capacitive structures connected by one or more inductive transmission lines. In some examples, the parallel capacitive structures may be spaced by an integer fraction of the millimeter or terahertz wavelength (e.g., λ/2, λ/4, λ/6, etc). The resonant drive electrode is positioned on the electro-optic device to influence the optical properties of an optical waveguide that includes an electro-optic polymer. The optical device may include a Mach-Zehnder modulator, a phase modulator, a micro-ring resonator, a directional coupler, or any combination of these or similar structures. Referring to FIG. 2, in one embodiment, the drive electrode is a stepped impedance electrode (20). In the depicted example, the overall length are about 1.849 microns, the length and width of the inductive transmission lines (22) are approximately 180 microns and 8 microns, respectively, and the length and width of the parallel capacitive structures (24) are approximately 190 microns and 40 microns, respectively, which would produce a resonance at approximately 94 GHz. In various implementations, the length and widths of the inductive transmission lines segments and the parallel capacitive segments can be varied to resonate with other millimeter wave frequencies and/or terahertz frequencies. FIG. 3 illustrates an exemplary frequency response characteristic for the drive electrode 20 described above with reference to FIG. 2.

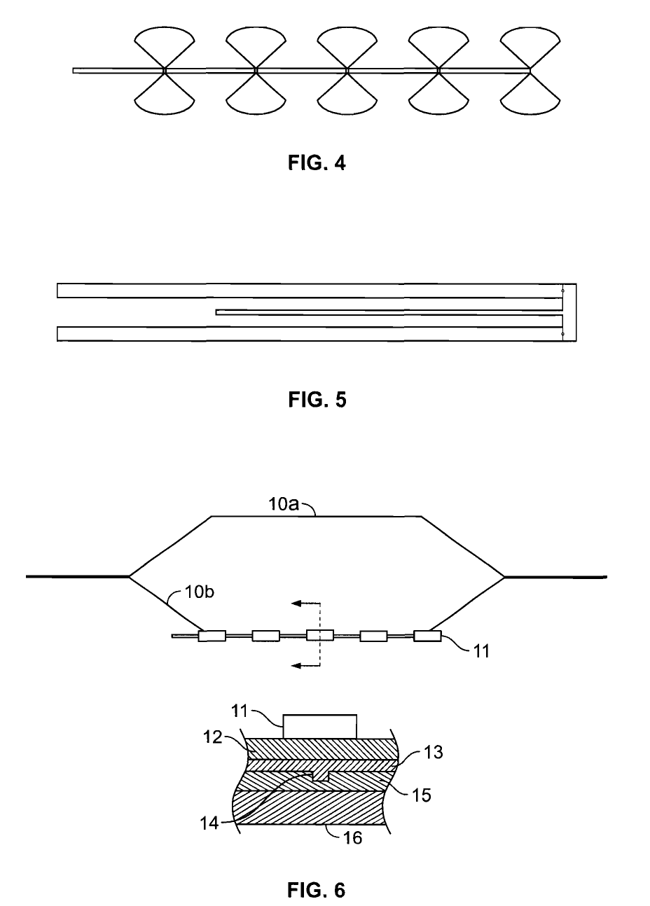

FIGS. 4 and 5 illustrate other embodiments with different parallel capacitive structures that may be used in various embodiments of the resonant drive electrode. FIG. 4 illustrates an embodiment with an exemplary transmission (40) line with radial stub resonators (42) distributed at ¼ or ½ of the wavelength (λ) of interest. FIG. 5 shows another embodiment with an exemplary bent open stub resonator (50). In some examples, the bent open stub-resonator (50) may be spaced at λ/4 or λ/2 of the wavelength of interest, or at integer multiples thereof. In some other implementations, spacings between features of the resonant drive electrode may include dimensions that are substantially integer fractions of the wavelength of interest.

FIG. 6 illustrates a top view of an exemplary Mach-Zehnder interferometer (60) with an optical waveguide that splits into two arms 10a, 10b. The depicted interferometer (60) includes an optical waveguide with a first arm (10a) and a second arm (10b), and a resonant drive electrode (11) that corresponds to the second arm (10b). In this case, the resonant drive electrode (11) is positioned to change the optical properties in the second arm (10b).

In another embodiment, a first resonant drive electrode corresponds to a first arm of a Mach-Zehnder modulator and a second resonant drive electrode corresponds to the second arm of the Mach-Zehnder modulator, wherein the first and second resonant electrodes resonate at different frequencies. When two or more different resonant electrodes are used, one device may be tuned to detect two or more millimeter to terahertz frequencies.

In some embodiments, an electro-optic waveguide or portion of an electro-optic waveguide may have more than one resonant electrode. In such examples, each of the resonant electrodes may be tuned to a different frequency. In this manner one electro-optic waveguide or portion of an electro-optic waveguide may be used to detect more than one different millimeter to terahertz frequencies.

In response to free-space millimeter or terahertz wave radiation signals impinging on the resonant drive electrode (11), a voltage transient may be induced in the second arm (10b) of the Mach-Zehnder. The induced voltage may produce a change in velocity between an optical signal propagating through the first arm (10a) and an optical signal propagating through the second arm (10b) that corresponds to the electrode (11). With a change in velocity in one arm, the optical signals in the two arms may combine with constructive or destructive interference. Accordingly, the optical output signal may exhibit intensity modulation in response to the impinging radiation.

In some implementations, the modulation of the optical signal may be converted to a modulated electrical signal by, for example, a photodetector circuit. Some embodiments may detect the presence, frequency, intensity, and/or wavelength of the impinging radiation, as well as time-varying characteristics of the impinging radiation. In some implementations, such a photodetector output may be coupled to a processor. The processor may be coupled to a data store that stores instructions that, when executed by the processor, cause the processor to determine characteristics about the impinging radiation. Examples of characteristics that may be determined may include, but are not limited to, presence or absence of the impinging signal near the resonant frequency, wavelength components, amplitude, modulation period, modulation frequency, data and/or timing (e.g., clock) signals contained in the impinging radiation. In some examples, communication signals may be decoded and/or stored as serial data and/or data streams. In some examples, a millimeter wavelength and/or terahertz signal carrier signal may be modulated to encode serial data (e.g., using 8b/10b encoding), such that an embodiment of the detector may receive the signal from a wireless medium for subsequent demodulation, decoding, and/or data recovery. Some systems may store such data in a data store for subsequent processing, display, and/or transmission.

FIG. 6 also shows, according to one embodiment, a cross section taken through the resonant drive electrode (11). The depicted cross-sectional view shows the resonant drive electrode (11), a top clad (12), a layer of electro-optic polymer (13), a trench of the electro-optic polymer (14) that forms the optical waveguide, a bottom clad (15), and a bottom electrode (16). The total thickness of the waveguide (layers 12-15) is typically 7 to 15 microns. In most embodiments, the top clad (12) and bottom clad (15) are cross-linked passive polymers. The fabrication of the Mach-Zehnder modulator may limit the dimensions of the absorption electrode. In one embodiment, the height of the optical waveguide is 9 microns and the associated mean dielectric constant of in three polymer stack (12, 13, and 15) ranges from 3.0 to 3.5. These dimensions and the frequency of interest determine the quarter (λ/4) or half wavelength (λ/2) dimensions. The optical waveguide is approximately 3.5 microns wide and the optical mode extends beyond this dimension (into the clads (12 and 15)), therefore the minimum width of the electrode (11) is set at 8 microns so that any terahertz field absorbed will encompass the optical signal. Likewise the first arm (10) and the drive electrode (11) of the Mach-Zehnder are usually separated by 50 microns to 100 microns, setting the upper bounds of the width of the electrodes (11 and 16) and therefore the realizable impedance of the electrode (11) at a given interest frequency. Typically, the bottom electrode (16) is substantially planar, and the bottom electrode (16) may be a ground plane. In some embodiments, the bottom electrode (16) may be configured other than as a feed line to a slot line antenna structure. Thus the length, width, height, and dielectric constant of the various polymer layers (12, 13 and 15) and bottom electrode (16) may establish criteria to determine other design aspects of the absorption electrode at a particular frequency of interest.

Although various embodiments have been described with reference to the figures, other embodiments may be implemented. For example, a device may include a tuned resonant electrode configured to modulate an optical signal propagating through an electro-optically active optical waveguide. A number of devices may be combined together into an array. An array may have M×1, M×N, or M×M devices, for example. The devices of an array may include a group of devices with resonant electrodes tuned to absorb radiation at a first frequency band and another group of devices tuned to absorb radiation at a second frequency band. Embodiments may include resonant electrodes that are tuned to multiple resonance frequencies to effectively include frequency bands that may or may not overlap. In some embodiments, one or more devices in an array may each absorb one or more frequency bands, some of which may overlap. In other embodiments, devices within groups of an array may include more than one resonant electrode, wherein each electrode is tuned to a different frequency. Accordingly, optical signals may be modulated in response to energy received within the selected frequency range(s) of the corresponding resonant electrode.

In some implementations, a single device or an array of devices may receive incident radiation after it has passed through a lens and/or an optical system. A lens and/or optics may be provided to focus, re-direct, collimate, filter, or otherwise manipulate the incident radiation at one or more tuned resonant electrodes. A package or a housing may be provided to contain a lens and/or optics and one or more devices, each of which may include one or more tuned resonant electrodes. In some embodiments, packaging may be at least partially hermetically sealed.

In various embodiments, a tuned receiving electrode may absorb radiation within a selected frequency range (e.g., a bandwidth). By way of example, and not limitation, the bandwidth may be on the order of, for example, 1 kHz, 100 kHz, 1 MHz, 10 MHz, 100 MHz, 1 GHz, 10 GHz, or 100 GHz, such as about 3 GHz, for example. Peak absorption may occur near a resonant frequency in the selected range. In various applications, radiation received and absorbed by the tuned resonant electrode may include electromagnetic radiation, which may be from natural and/or manufactured sources. For example, radiation may be detected from natural or synthetic materials (e.g., metallic substances) and/or artificial sources, such as a terahertz generator.

An example of using an electro-optic modulator to modulate an optical signal with an electric field is described by Koenig in U.S. patent application Ser. No. 11/299,007, entitled “Waveguide Interface,” and filed on Dec. 9, 2005, the entire contents of which are incorporated herein by reference.

All patents, patent applications, and publications cited within this application are incorporated herein by reference to the same extent as if each individual patent, patent application or publication was specifically and individually incorporated by reference.

A number of implementations have been described. Nevertheless, it will be understood that various modifications may be made. For example, advantageous results may be achieved if the steps of the disclosed techniques were performed in a different sequence, if components in the disclosed systems were combined in a different manner, or if the components were replaced or supplemented by other components. Some implementations may be performed on modules or hardware not identical to those described. Accordingly, other implementations are within the scope of the following claims.

What is claimed is:

1. A device to detect electromagnetic radiation, the device comprising:
a resonant drive electrode comprising structural elements configured to tune the resonant drive electrode to absorb radiation in a selected frequency band, said structural elements comprising periodic parallel capacitive structures connected by inductive transmission lines;
a reference conductor arranged such that electric fields extend between the resonant drive electrode and the reference conductor in response to said absorbed radiation; and
an electro-optic waveguide between the resonant drive electrode and the reference conductor, wherein an optical signal propagating through the electro-optic waveguide responds to said electric fields.

2. The device of claim 1, wherein the resonant drive electrode comprises a stepped impedance line.

3. The device of claim 1, wherein the resonant drive electrode comprises at least one radial stub.

4. The device of claim 1, wherein the receiving electrode comprises an open stub.

5. The device of claim 1, wherein the electro-optic waveguide comprises a Mach-Zehnder waveguide.

6. The device of claim 1, further comprising a plurality of elements arranged in an array, each element comprising one or more of the resonant drive electrodes and one or more of the electro-optic waveguides.

7. The device of claim 1, wherein the reference conductor comprises a ground plane.

8. The device of claim 1, wherein the selected frequency band includes frequencies above about 100 GHz.

9. The device of claim 1, wherein the selected frequency band includes terahertz frequencies.

10. The device of claim 1, wherein the parallel capacitive structures are spaced by about an integer fraction of the wavelength of the radiation in the selected frequency band.

11. The device of claim 1, wherein the parallel capacitive structures are spaced by about an integer multiple of ¼ of the wavelength of the radiation in the selected frequency band.

12. An electro-optical system to image received electromagnetic signals, the system comprising:
a resonant drive electrode arranged in a first planar layer to receive an incident electromagnetic signal, the resonant drive electrode comprising structural elements configured to tune the resonant drive electrode to absorb said incident electromagnetic signal in a predetermined frequency band and to substantially attenuate absorption of the received electromagnetic signal outside of the predetermined frequency band, said structural elements comprising periodic parallel capacitive structures connected by inductive transmission lines; and
an electro-optically active optical waveguide in a second planar layer substantially parallel to the first planar layer and arranged such that an optical signal propagating in the waveguide responds to said absorbed electromagnetic signal.

13. The system of claim 12, wherein the waveguide comprises a Mach-Zehnder waveguide.

14. The system of claim 12, further comprising a lens to collimate the received electromagnetic signals.

15. The system of claim 12, wherein the predetermined frequency band is associated with a resonance in the resonant drive electrode.

16. The system of claim 12, wherein the predetermined frequency band comprises frequencies between about 50 GHz and at least about 1 THz.

17. The system of claim 12, wherein the predetermined band comprises frequencies above 1 THz.

18. The system of claim 12, wherein the predetermined band includes 120 GHz.

19. The system of claim 12, wherein the receiving electrode comprises a stepped impedance line.

20. The system of claim 12, wherein the receiving electrode comprises at least one radial stub.

21. The system of claim 12, wherein the receiving electrode comprises an open stub.

22. The system of claim 12, wherein the receiving electrode comprises slots distributed at multiples of a quarter wavelength at points along a transmission line structure.

23. The system of claim 12, further comprising a biasing electrode in the first planar layer to apply a controllable electric field bias to manipulate an optical signal propagating in the waveguide.

24. The system of claim 12, further comprising a dielectric layer between the first and second planar layers.

25. The system of claim 24, wherein the dielectric layer comprises a polymer.

26. The system of claim 24, further comprising a second electrode at a substantially fixed electric potential, the second electrode being substantially in a third planar layer substantially parallel to the first planar layer, wherein the second planar layer lies between the first and third planar layers.

27. The system of claim 26, further comprising a second dielectric layer between the third and second layers.

28. The system of claim 12, wherein the parallel capacitive structures are spaced by about an integer fraction of the wavelength of the radiation in the predetermined frequency band.

29. The system of claim 12, wherein the parallel capacitive structures are spaced by about an integer multiple of ¼ of the wavelength of the radiation in the predetermined frequency band.
